(19) United States
(12) Patent Application Publication
(10) Pub. No.: US 2009/0248521 A1
(43) Pub. Date: Oct. 1, 2009

(54) Managing Accounts Such as Advertising Accounts

(76) Inventor: Maneesh Arora, Santa Clara, CA (US)

Correspondence Address: FISH & RICHARDSON P.C., PO BOX 1022, MINNEAPOLIS, MN, 55440-1022, US

(21) Appl. No.: 12/407,456

(22) Filed: Mar. 19, 2009

Related U.S. Application Data
(60) Provisional application No. 61/040,876, filed on Mar. 31, 2008.

(51) Int. Cl. G06Q 10/00; G06Q 30/00; H04L 9/32; G06F 3/048

(52) U.S. Cl. 705/14; 705/1; 726/1; 715/780

(57) ABSTRACT

A method includes: creating a plurality of advertising accounts associated with an advertiser, each of the advertising accounts including multiple fields defining specifics of performing advertising on behalf of the advertiser and being individually accessible to the advertiser through a login procedure; grouping the plurality of advertising accounts in an account center associated with the advertiser that provides the advertiser access to the advertising accounts; providing, in the account center, an editing function for use in modifying any of the plurality of advertising accounts, the editing function identifying the multiple fields included in the advertising accounts associated with the advertiser; receiving a user input entered using the account center, the user input requesting a modification to at least two of the advertising accounts; modifying the at least two of the advertising accounts based at least in part on the user input; and storing the at least two modified advertising accounts.

### CLAIM OF PRIORITY

This application claims priority under 35 USC § 119(e) to U.S. Provisional Application Ser. No. 61/040,876, filed on Mar. 31, 2008, the entire contents of which are hereby incorporated by reference.

### TECHNICAL FIELD

This document relates to managing a plurality of accounts.

### BACKGROUND

In the online environment advertising has taken on a substantial presence. One example of online advertising is that an advertisement is displayed as an identifiable portion or area on the screen, for example in form of a banner or a box. The advertising content can be displayed on a screen where there is also other content.

Users or organizations that advertise sometimes have more than one advertisement. One example is that a company can have advertisements for several of its products. The company can then seek to have the advertisement for a particular product presented in a context that somehow relates to the product, for example when someone enters the name of the product (or another relevant key word) into a search engine.

### SUMMARY

The invention relates to managing a plurality of accounts.

In a first aspect, a computer-implemented method includes creating a plurality of advertising accounts associated with an advertiser, each of the advertising accounts including multiple fields defining specifics of performing advertising on behalf of the advertiser and being individually accessible to the advertiser through a login procedure. The method includes grouping the plurality of advertising accounts in an account center associated with the advertiser, the account center providing the advertiser access to the advertising accounts. The method includes providing, in the account center, an editing function configured for use in modifying any of the plurality of advertising accounts, the editing function identifying the multiple fields included in the advertising accounts associated with the advertiser. The method includes receiving a user input entered using the account center, the user input requesting a modification to at least two of the advertising accounts. The method includes modifying the at least two of the advertising accounts based at least in part on the user input. The method includes storing the at least two modified advertising accounts.

Implementations can include any, all or none of the following features. The method can further include providing, for a plurality of accounts that are associated with an entity and accessible to the entity through a login procedure, an editing function identifying multiple fields of the accounts for editing; receiving a user input entered using the editing function and requesting a modification to at least two of the accounts; and modifying the at least two accounts based at least in part on the user input. The user input can further include an identification of the at least two accounts, wherein the modification is also based at least in part on the identification. The user input can further include a criterion for identifying the at least two accounts among the plurality of accounts. The method can further include identifying the at least two accounts using the criterion. The at least two accounts can be identified by successively evaluating the criterion for each of the plurality of accounts. The plurality of accounts can be advertising accounts and the criterion can be at least one selected from: an advertising cost, an advertising reach, an advertising type, an advertising content, a measure of advertising effectiveness, and combinations thereof. The plurality of accounts can be advertising accounts and the modification can be at least one selected from: a budget adjustment, a bid adjustment, an advertising content adjustment, an advertising type adjustment, an advertising scheduling adjustment, an adjustment of a criterion for publishing an advertisement, and combinations thereof. The method can further include providing an account center configured for making the editing function available. At least some of the plurality of accounts can exist before the account center is provided, and the method can further include grouping the existing accounts in the account center. The method can further include creating at least some of the plurality of accounts so that they are associated with the account center. The method can further include providing at least another account center and nesting the other account center within the account center. The modification can be applied to accounts in both the account center and in the other account center. The user input can request a plurality of modifications, and the method can further include performing the plurality of modifications on the at least two accounts in a batch process. The method can further include configuring the editing function to identify the multiple fields of the accounts. Configuring the editing function can include accessing the plurality of accounts to determine the multiple fields. The access of the plurality of accounts may not involve using the login procedure. The modification can be performed in response to an evaluation that a criterion is satisfied, the criterion can be defined in advance as associated with the user input for modifying the at least two accounts.

In a second aspect, a computer program product is tangibly embodied in a computer-readable medium and includes instructions that, when executed, generate on a display device a graphical user interface for managing a plurality of advertising accounts. The graphical user interface includes a field modification area for a user to enter a modification for any of multiple fields included in a plurality of accounts, each of the accounts being associated with an entity and accessible to the entity through a login procedure. The graphical user interface includes an account selection area for the user to select at least one of the plurality of accounts for making the modification. The account selection area can provide that the user can enter a criterion for identifying the at least one account among the plurality of accounts. The plurality of accounts can be advertising accounts and the criterion can be at least one selected from: an advertising cost, an advertising reach, an advertising type, an advertising content, a measure of advertising effectiveness, and combinations thereof, and the modification can be at least one selected from: a budget adjustment, a bid adjustment, an advertising content adjustment, an advertising type adjustment, an advertising scheduling adjustment, an adjustment of a criterion for publishing an advertisement, and combinations thereof.

Implementations can provide any, all or none of the following advantages. Online advertising can be improved. Account management can be improved. A system can provide a simplified and more efficient process for users to make changes in more than one advertising account. Consistency among accounts and sub-accounts can be maintained.

The details of one or more embodiments are set forth in the accompanying drawings and the description below. Other features and advantages will be apparent from the description and drawings, and from the claims.

### DESCRIPTION OF DRAWINGS

FIG. 1 is a block diagram showing an example of a system for managing and using multiple accounts.

FIG. 2 is a block diagram showing an example of a user interface for managing multiple accounts.

FIG. 3 is a flow chart showing an example of a process for managing multiple accounts.

FIG. 4 is a block diagram of a computing system that can be used in connection with computer-implemented methods described in this document.

Like reference symbols in the various drawings indicate like elements.

### DETAILED DESCRIPTION

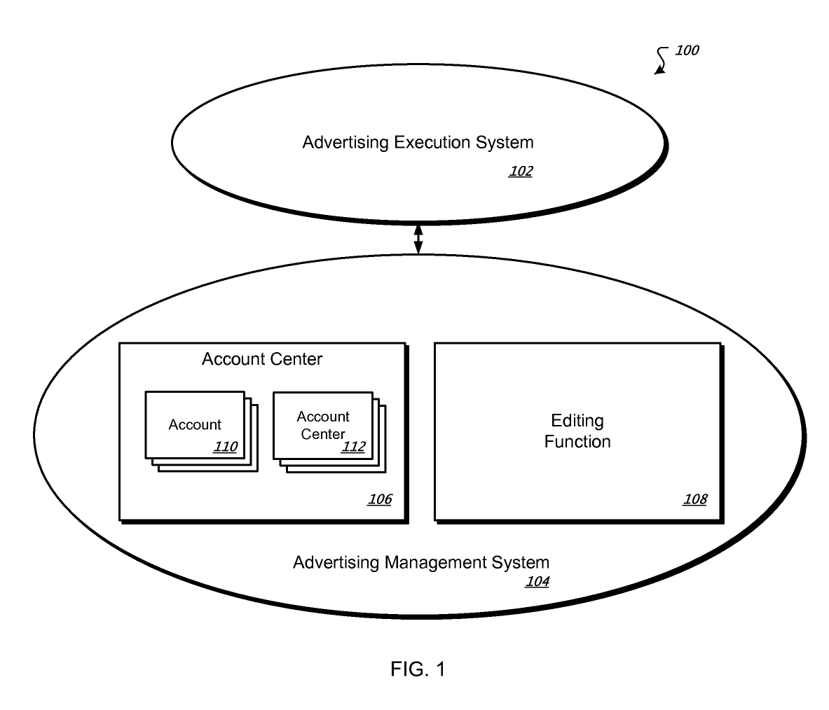

FIG. 1 is a block diagram showing an example of a system 100 for managing and using multiple accounts. The system 100 here includes an advertising execution system 102, and an advertising management system 104. The advertising execution system 102 and the advertising management system 104 are capable of communication through a private network or the Internet, to name a few examples. The advertising execution system 102 provides content to one or more displays with areas capable of displaying advertising content. For example, Internet web sites with advertising content areas, search engine results pages, or cellular phone devices may all be capable of displaying content provided by the advertising execution system 102. In other implementations, the advertising execution system 102 and the advertising management system 104 can be distributed differently among more than one system, or can be combined in a single system.

In some implementations, the advertising execution 102 may provide advertising content to other systems not shown presently in FIG. 1. For example, the advertising execution system 102 may send advertising information to a third party company to be formatted or converted for display on a mobile device.

The advertising management system 104 provides one or more functions for advertisers to create and/or manage their advertisement accounts. The advertising management system 104 can include one or more account center components 106, and one or more editing function components 108. In some implementations, the account center 106 can manage one or more accounts 110, and one or more account centers 112. For example, the account center 106 can provide functions such as user editing, displaying, or managing accounts 110 and/or account centers 112.

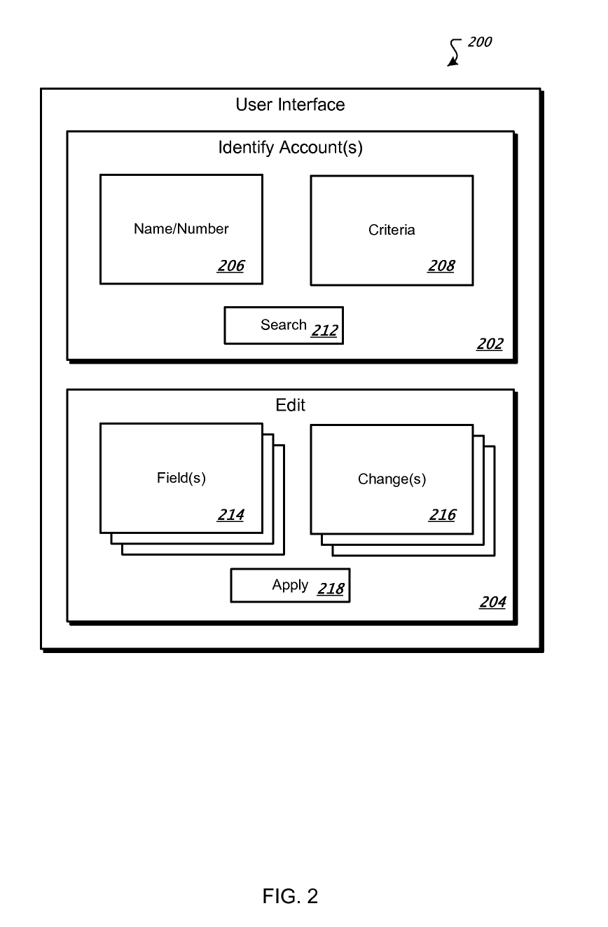

In some implementations, multiple accounts 110 can be associated with one advertiser. Here, the accounts 110 can include multiple fields 214 (FIG. 2) containing advertiser specific information for performing advertising. For example, any or all of the accounts 110 can contain an identification of a particular advertisement and one or more criteria for when the identified advertisement should be displayed. By referring to such account content, the advertising management system 104 and/or the advertising execution system 102 can determine, in real time, which advertisement to display and when, for example. In some implementations, the accounts 110 can be accessible, by the user or organization to which they relate, through individual advertiser logins, or grouped together and managed through the account center 112 login.

In some implementations, advertisers may wish to manage multiple account centers 112 using a parent account center 106. Managing multiple account centers 112 using a parent account center 106 may provide ease of account maintenance, faster changes to advertising campaign structures, or generally more efficient methods of changing or editing multiple accounts managed by a single advertiser.

The editing function 108 can provide functionality to access and/or modify information contained in one or more advertising accounts. The information can include one or more data fields associated with an individual advertising account. In some implementations, the editing function 108 can provide for modification of multiple accounts without requiring a user to make a login access for each individual account 110 managed by a particular advertiser. By having direct access to the advertiser account data, the editing function 108 may provide specific data fields 214 associated with an advertiser account as shown in FIG. 2, system 200.

FIG. 2 shows an example of a user interface 200 for managing multiple accounts. The user interface 200 can include display areas that can present information about one or more advertising accounts associated with a particular advertiser. For example, the user interface 200 may initiate the display of advertiser information as a result of a user of the account(s) logging in at a web site. In some implementations, the user interface 200 can include an identify accounts 202 area for identifying accounts, and an edit 204 area for entering one or more edits to be applied to the identified account(s). Here, the user interface 200, including the identify accounts 202 area, and the edit 204 area are provided by the editing function 108 (FIG. 1).

Identifying advertiser accounts can be accomplished in several ways. In an exemplary implementation, advertiser accounts may be identified by name/number 206, by criteria 208, or other combinations of identifying data. For example, account information may be stored in a database, and information from the database retrieved by the editing function 108 component of the advertising management system 100. Here, the editing function 108 may present information retrieved from the database such as the name/number 206 to help advertisers identify accounts in the identify accounts 202 area of user interface 200. Examples of criteria 208 may include advertising type, advertising reach, advertising content, a measure of advertising effectiveness, and combinations thereof. As a conceptual example, a user can specify in the area 208 that he or she is seeking all accounts where the number of clicks per advertisement presentation falls above or below a certain value.

In some implementations, the identify accounts 202 area of the user interface 200 can include a search 212 button. The search button 212 can be activated, for example, by a computer mouse click on the search button 212 area of the user interface. In some implementations, the search button 212 can initiate retrieval of the accounts identified by name/number 206 and/or by the criteria 208. In some implementations, clicking the search button 212 can facilitate the retrieval of information displayed in the edit 204 area of the user interface 200, such as identities or other characteristics of the particular fields included in the advertising accounts.

The edit 206 area of user interface 200 can present advertiser account information such as fields 214, or other aspects of the account objects as a result of selecting identifying information in the identify accounts 202 area of user interface 200. The advertiser may wish to change one or more fields in a fields area 214 by selecting one or more fields and subsequently selecting one or more changes 216 to be applied to the selected fields 214. For example, the field area 214 may include such data as budget, and the example change 216 to be applied to budget might be to increase it by $0.12 per click. In some implementations, the edits made by the user are confirmed by selecting or activating an apply button 218. Selecting the apply button 218 may cause the system 100 to receive the one or more fields in the area 214 and associated changes 216 to be applied to the selected advertiser accounts.

Following is an example of how the user interface 200 can be employed. A user wishes to modify its advertising by increasing the advertising budget for certain advertisements. For strategy reasons, the user decides that this change should be applied to weakly performing advertisement accounts. The user therefore manipulates the criteria area 208 to specify that the changes that are to be made shall be applied only to poorly performing accounts. In the area 208, the user can specify a value to be used as the threshold for identifying the relevant accounts. Upon clicking the search button 212, the account(s) matching this criterion, if any, are identified by the system. In some implementations, the system identifies fields of the identified accounts for populating the fields area 214. The user enters or otherwise specifies the desired budget increase in the area 216 (optionally together with any other change that is desired or necessary depending on the situation). Upon activating the apply button 218 the system applies the change(s) to the identified account(s) without requiring the user to individually open and/log into each of the affected accounts.

In some implementations, multiple accounts can be updated by a fully or partly automated process. Assume that a user is managing ten subaccounts. For example, the user can make a change in the user interface to update all ten accounts. As another example, the user can set up a trigger that will update all ten accounts when one or more preselected criteria are met. In some implementations, the following criterion can be used: If overall click-through rate across all subaccounts drops below 1.0%, then increase the cost-per-click bid of all advertising groups in all subaccounts by $0.50. Other criteria and/or parameters can be used.

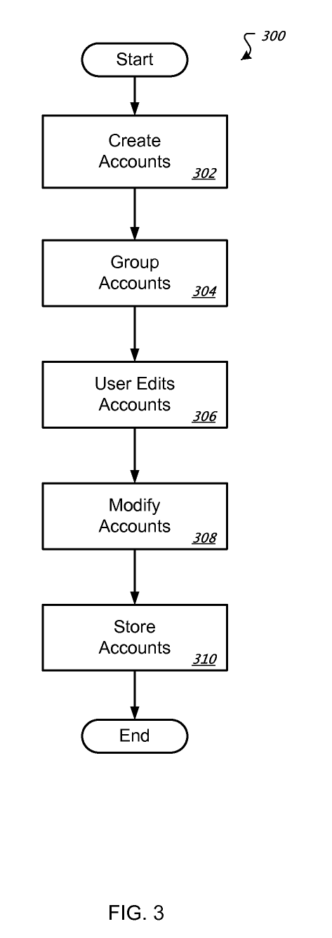

FIG. 3. is a flow chart showing an example of a process 300 for managing multiple accounts. The process 300 can be performed by a processor executing instructions, for example in a system as depicted in FIG. 1. In step 302, advertisers create one or more accounts, with each of the advertising accounts including multiple fields defining specifics of performing advertising on behalf of the advertiser. The created accounts can be individually accessible to the advertiser through a login procedure. In some implementations, accounts may already exist, and step 302 can be omitted. Step 302 may be repeated to create multiple accounts. For example, accounts 110 can be created in one or more iterations during step 302.

In step 304, multiple accounts may be grouped together to be managed in the account center 106 described previously in more detail. The individual accounts can be associated with the advertiser, and a single login may be created for the account center 106 during step 304. For example, account centers 112 and account center 106 may be grouped together to be managed using a single account center not presently shown in FIG. 1. The account center can be created before, during or after the creation of the individual accounts.

In step 306, an editing function provides functionality to modify multiple advertising accounts. The editing function can identify one or more data fields which are included in the advertising accounts associated with the advertiser. The advertiser may select one or more of the data fields, and enter a change to be applied to the data fields during the editing step 306.

In step 308, the system 100 can modify multiple accounts based on the selected data fields and selected change to be applied from step 306. The modification to the account can be stored in step 310 within the identified advertising accounts. The modified accounts can then be accessible for use, for example, by the advertising management system 104.

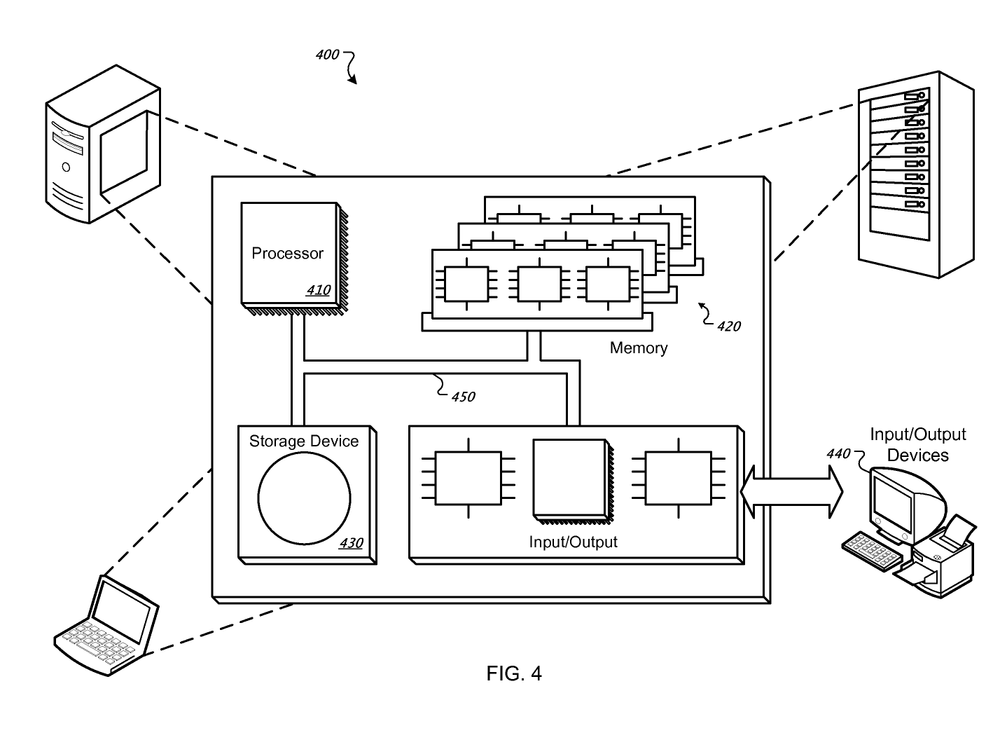

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for managing a plurality of advertising accounts, the method comprising:
creating a plurality of advertising accounts associated with an advertiser, each of the advertising accounts including multiple fields defining specifics of performing advertising on behalf of the advertiser and being individually accessible to the advertiser through a login procedure;
grouping the plurality of advertising accounts in an account center associated with the advertiser, the account center providing the advertiser access to the advertising accounts;
providing, in the account center, an editing function configured for use in modifying any of the plurality of advertising accounts, the editing function identifying the multiple fields included in the advertising accounts associated with the advertiser;
receiving a user input entered using the account center, the user input requesting a modification to at least two of the advertising accounts;
modifying the at least two of the advertising accounts based at least in part on the user input; and
storing the at least two modified advertising accounts.

2. A computer-implemented method for managing a plurality of accounts, the method comprising:
providing, for a plurality of accounts that are associated with an entity and accessible to the entity through a login procedure, an editing function identifying multiple fields of the accounts for editing;
receiving a user input entered using the editing function and requesting a modification to at least two of the accounts; and
modifying the at least two accounts based at least in part on the user input.

3. The computer-implemented method of claim 2, wherein the user input further includes an identification of the at least two accounts, wherein the modification is also based at least in part on the identification.

4. The computer-implemented method of claim 2, wherein the user input further includes a criterion for identifying the at least two accounts among the plurality of accounts.

5. The computer-implemented method of claim 4, further comprising identifying the at least two accounts using the criterion.

6. The computer-implemented method of claim 5, wherein the at least two accounts are identified by successively evaluating the criterion for each of the plurality of accounts.

7. The computer-implemented method of claim 4, wherein the plurality of accounts are advertising accounts and wherein the criterion is at least one selected from: an advertising cost, an advertising reach, an advertising type, an advertising content, a measure of advertising effectiveness, and combinations thereof.

8. The computer-implemented method of claim 4, wherein the plurality of accounts are advertising accounts and wherein the modification is at least one selected from: a budget adjustment, a bid adjustment, an advertising content adjustment, an advertising type adjustment, an advertising scheduling adjustment, an adjustment of a criterion for publishing an advertisement, and combinations thereof.

9. The computer-implemented method of claim 2, further comprising providing an account center configured for making the editing function available.

10. The computer-implemented method of claim 9, wherein at least some of the plurality of accounts exist before the account center is provided, further comprising grouping the existing accounts in the account center.

11. The computer-implemented method of claim 9, further comprising creating at least some of the plurality of accounts so that they are associated with the account center.

12. The computer-implemented method of claim 9, further comprising providing at least another account center and nesting the other account center within the account center.

13. The computer-implemented method of claim 12, wherein the modification is applied to accounts in both the account center and in the other account center.

14. The computer-implemented method of claim 2, wherein the user input requests a plurality of modifications, further comprising performing the plurality of modifications on the at least two accounts in a batch process.

15. The computer-implemented method of claim 2, further comprising configuring the editing function to identify the multiple fields of the accounts.

16. The computer-implemented method of claim 15, wherein configuring the editing function comprises accessing the plurality of accounts to determine the multiple fields.

17. The computer-implemented method of claim 16, wherein the access of the plurality of accounts does not involve using the login procedure.

18. The computer-implemented method of claim 2, wherein the modification is performed in response to an evaluation that a criterion is satisfied, the criterion having been defined in advance as associated with the user input for modifying the at least two accounts.

19. A computer program product tangibly embodied in a computer-readable medium, the computer program product including instructions that, when executed, generate on a display device a graphical user interface for managing a plurality of advertising accounts, the graphical user interface comprising:
a field modification area for a user to enter a modification for any of multiple fields included in a plurality of accounts, each of the accounts being associated with an entity and accessible to the entity through a login procedure; and
an account selection area for the user to select at least one of the plurality of accounts for making the modification.

20. The computer program product of claim 19, wherein the account selection area provides that the user can enter a criterion for identifying the at least one account among the plurality of accounts.

21. The computer program product of claim 20, wherein:
the plurality of accounts are advertising accounts and the criterion is at least one selected from: an advertising cost, an advertising reach, an advertising type, an advertising content, a measure of advertising effectiveness, and combinations thereof, and
the modification is at least one selected from: a budget adjustment, a bid adjustment, an advertising content adjustment, an advertising type adjustment, an advertising scheduling adjustment, an adjustment of a criterion for publishing an advertisement, and combinations thereof.
